(19) United States
(12) Patent Application Publication
(10) Pub. No.: US 2011/0304531 A1
(43) Pub. Date: Dec. 15, 2011

(54) METHOD AND SYSTEM FOR INTERFACING AND INTERACTION WITH LOCATION-AWARE DEVICES

(76) Inventor: Peter Brooks, Osterville, MA (US)

(21) Appl. No.: 12/901,693

(22) Filed: Oct. 11, 2010

Related U.S. Application Data
(60) Provisional application No. 61/353,642, filed on Jun. 10, 2010.

(51) Int. Cl. G09G 5/00

(52) U.S. Cl. 345/156

(57) ABSTRACT

A system and a method of using the system includes a motion detection subsystem for detecting a motions applied to a computing device about one or more axes. A storage subsystem stores motion command definitions. A motion processing subsystem is included for characterizing the motions, retrieving command definitions, comparing the characterized motions with the retrieved command definitions, and retrieving commands associated with matched command definitions. A command processing subsystem is included for defining new motions and storing new characterized motions as entries in the command definition, retrieving stored characterized motions and storing named characterized motions as entries in the command definitions, associating commands with stored characterized motions and storing the associated commands as entries in the command definitions, and processing retrieved commands for modification of and interaction with displayed information of the computing device and saving processing results.

### CROSS- REFERENCE TO RELATED APPLICATIONS

The present Utility patent application claims priority benefit of the U.S. provisional application for patent Ser. No. 61/353,642 and entitled “Using Movement to Generate Commands That Affect Visualizations Generated on Devices”, filed on Jun. 10, 2010 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to mobile and/or other location-aware and motion-aware devices. More particularly, the invention relates to modification of displays of information as presented on a location-aware device.

### BACKGROUND OF THE INVENTION

Mobile communication and other location-aware and motion-aware devices, such as mobile phones, smartphones, (Personal Digital Assistants) PDAs, tablets, and portable laptops, often support the capability to present a user with visualizations on a Graphical User Interface (GUI) of location-based data such as a geographical illustration (e.g. map) or locations of Points of Interest (POI) presented on a geographical illustration. The presented geographical illustration may be geo-centered based on the current device location or may be centered based on a user selection.

For example, such devices often present geographical illustrations to a user upon which may be illustrated POIs such as restaurants or gas stations. Devices such as mobile phones, smartphones, PDAs, tablets, and portable laptops may often include location-aware capabilities enabling a user of the device to (1) determine its current position and present the current position on a geographical illustration, (2) enable a user to identify a geographic position, either by directly specifying a location or by indirectly specifying a location by choosing a location-specific item such as a restaurant, or (3) present a geographical illustration generated by various other applications. Additionally, descriptions for the location of POIs (e.g. addresses) may be presented on a geographical illustration for viewing by a user.

User interactions may operate to affect the characteristics geographical illustrations being presented to a user. Altering the characteristics of a geographical illustration being presented on mobile devices, such as changing the scale of the geographical illustration being displayed, the geographical illustration focus areas, heading direction, etc. may be limited to textual data entry and user interface features such as sliders and selections applied via a touch-screen.

The POIs or other data on a geographical illustration may often be presented in a data list as well. Scrolling a list of data (e.g. list of restaurants) on a mobile device may be limited by a requirement to enter text commands or use interfaces such as sliders and flicks to scroll the list up or down. Furthermore, the same user interactions previously discussed may be required for performing other interface activities even though a differing interaction may provide for a more efficient interaction.

Interfacing and interacting with mobile communication and other location-aware and motion-aware devices may present difficulties for users. For example, the devices may offer small user input control devices (e.g. keypad) which may be difficult for users to efficiently operate. Also, user input control devices may have small and limited sets of features for interaction. Additionally, the mechanisms for entering information and selecting operating choices for mobile communication devices may be rudimentary as compared to conventional computer user interfaces and may present an inefficient and difficult to operate interface.

In view of the foregoing, there is a need for improved techniques for interfacing and interaction with location-aware mobile devices.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A-D illustrates display of information as viewed by a user on a GUI for an exemplary embodiment of the present invention;

FIG. 2 illustrates a block diagram depicting an exemplary regionalized client/server communication system supporting location aware capabilities for providing motion and touch-screen motion commands, in accordance with an embodiment of the present invention;

FIG. 3 illustrates a detailed version of a motion subsystem, an exemplary embodiment of the present invention;

FIG. 4 illustrates a command hierarchy for an exemplary embodiment of the present invention;

FIG. 5 illustrates a motion command hierarchy for an exemplary embodiment of the present invention;

FIG. 6A-C illustrates operation of software/firmware for an exemplary embodiment of the present invention; and

FIG. 7 illustrates a typical computer system that, when appropriately configured or designed, may serve as a computer system for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a method and system for interfacing and interaction with location-aware devices is presented.

In one embodiment a method includes steps for detecting a motion applied to a mobile computing device, steps for characterizing the motion, steps for retrieving command definitions, steps for comparing the characterized motion with the retrieved command definitions, steps for retrieving a command associated with a matched command definition, and step for processing the retrieved command. Another embodiment further includes steps for applying variance parameters to the characterized motion. Yet another embodiment further includes steps for obtaining a positional location of the mobile computing device for displaying map information.

In another embodiment a method includes the steps of detecting a motion applied to a mobile computing device, wherein the motion comprises movement of the mobile computing device about one or more axes. The motion is characterized. Command definitions are retrieved. The characterized motion is compared with the retrieved command definitions. A command associated with a matched command definition is retrieved. A retrieved command to define a new motion is processed by capturing the new motion from movement of the mobile computing device about one or more axes, receiving a name for the new motion, characterizing the new motion, and storing the name and the characterized new motion as an entry in the command definitions. A retrieved command to select a stored characterized motion is processed by retrieving a selected characterized motion from the stored command definitions, receiving a name for the selected characterized motion, and storing the name and the selected characterized motion as an entry in the command definitions. A retrieved command to associate a command with a stored characterized motion is processed by receiving a command for the stored characterized motion, associating the received command with the stored characterized motion, and storing the associated command as an entry in the command definitions. A retrieved command for modification of and interaction with displayed information of the mobile computing device is processed and processing results are saved. Another embodiment further includes the step of applying variance parameters to the characterized motion. Yet another embodiment further includes obtaining variance parameters for the characterized new motion. Still another embodiment further includes obtaining variance parameters for the selected characterized motion. Another embodiment further includes requesting and receiving additional information from a server to process the retrieved command. Yet another embodiment further includes obtaining a positional location of the mobile computing device for displaying map information. In still another embodiment the positional location is obtained from a GPS. In another embodiment processing of the retrieved command modifies parameters of the displayed map information. In yet another embodiment processing the retrieved command modifies sector management of the displayed map information. In still another embodiment processing the retrieved command modifies location management of the displayed map information. In another embodiment the interaction comprises selecting from a list. In yet another embodiment the interaction comprises a challenge-response process.

In another embodiment a system includes a motion detection subsystem for detecting a motions applied to a mobile computing device about one or more axes. A storage subsystem stores motion command definitions. A motion processing subsystem is included for characterizing the motions, retrieving command definitions, comparing the characterized motions with the retrieved command definitions, and retrieving commands associated with matched command definitions. A command processing subsystem is included for defining new motions and storing new characterized motions as entries in the command definition, retrieving stored characterized motions and storing named characterized motions as entries in the command definitions, associating commands with stored characterized motions and storing the associated commands as entries in the command definitions, and processing retrieved commands for modification of and interaction with displayed information of the mobile computing device and saving processing results. Another embodiment further includes a communication interface for requesting and receiving additional information from a server to process retrieved commands. In yet another embodiment the motion processing subsystem further applies variance parameters to characterized motions. In still other embodiments the communication interface further receives a positional location of the mobile computing device for displaying map information and processing of the retrieved command modifies parameters of the displayed map information.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

A first embodiment of the present invention will be described which provides means and methods for modifying and interacting with a display of information as presented and viewed by a user on a GUI of a stand-alone device. Non-limiting examples of suitable stand-alone devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include Global Positioning System (GPS), Wi-Fi, cell-tower positioning systems, compasses, accelerometers, gyroscopes and magnetic sensors. Modification of and interaction with display of information as presented on a GUI may be initiated and controlled by user applying a single or series of motions to the suitable device. Non-limiting examples of applied motions include upward, downward, left, right, circular and textually shaped. For example for textually shaped, a user may perform a motion representing the alpha character “A”. Furthermore, non-limiting examples of applied motions include motion for any x-, y-, z- axis or combination thereof, for a specific distance of travel, for a specific time period or for motion bounded by coordinate limits. A motion subsystem located within or attached to a suitable device may process applied motions to effect modifications of and interactions with information as displayed on GUI. Non-limiting examples of processing which may be used by motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of map information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples of interactions performed with display of map information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Motion subsystem may receive positional location information or process positional location information from external entities and may be configured as stand-alone without requiring additional information from outside entities (e.g. networked servers) for processing and implementing applied motions. Non-limiting examples of external entities which motion subsystem may receive positional location information includes GPS, Wi-Fi, cell-tower positioning systems, compasses, accelerometers, gyroscopes and magnetic sensors.

In other embodiments of the present invention, a method and means will be described which provides for modifying and interacting with a display of information as presented and viewed by a user on a GUI of a suitable device which may be networked with a server device for accessing additional information. Non-limiting examples of suitable devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include GPS, Wi-Fi, cell-tower positioning systems, compasses, accelerometers, gyroscopes and magnetic sensors. Modification of and interaction with display of information as presented on a GUI may be initiated and controlled by user applying motions to the suitable device. Non-limiting examples of applied motions include upward, downward, left, right, circular and textually shaped. For example for textually shaped, a user may perform a motion representing the alpha character “A”. Furthermore, non-limiting examples of applied motions include motion for any x-, y-, z- axis or combination thereof, for a specific distance of travel, for a specific time period or for motion bounded by coordinate limits. A motion subsystem located within or attached to suitable device may process applied motions to effect modifications of and interactions with information as displayed on GUI. Non-limiting examples of processing which may be used by motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples of interactions performed with display of information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Motion subsystem may receive positional location information or process positional location information from external entities and may be configured for communicating with external entities (e.g. server) for acquiring additional information for processing and implementing applied motions. Non-limiting examples of information which may be acquired from external entities for processing of applied motions includes landmarks, places of business, highways, streets, roads, hazards, bodies of water and geographic terrain. Non-limiting examples of external entities which motion subsystem may receive positional location information includes GPS, Wi-Fi, cell-tower positioning systems, compasses, accelerometers, gyroscopes and magnetic sensors. Motion processing subsystem may operate to store a log of processing information. Non-limiting examples of uses for a log of processing information include viewing, analysis and diagnostics.

In other embodiments of the present invention, a method and means will be described which provides for modifying and interacting with a display of information as presented and viewed by a user on a GUI of a stand-alone device which may be networked with a server device for receiving updates of new information or receiving updates for replacing obsolete information. Non-limiting examples of suitable devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include GPS, Wi-Fi, cell-tower positioning systems, compasses, accelerometers, gyroscopes and magnetic sensors. Modification of and interaction with display of information as presented on a GUI may be initiated and controlled by user applying motions to the suitable device. Non-limiting examples of applied motions include upward, downward, left, right, circular and textually shaped. For example for textually shaped, a user may perform a motion representing the alpha character “A”. Furthermore, non-limiting examples of applied motions include motion for any x-, y-, z- axis or combination thereof, for a specific distance of travel, for a specific time period or for motion bounded by coordinate limits. A motion subsystem located within or attached to suitable device may process applied motions to effect modifications of and interactions with information as displayed on GUI. Non-limiting examples of processing which may be used by motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples for the types of graphical information which may be presented include road, satellite or terrain. Non-limiting examples of interactions performed with display of information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Motion subsystem may receive positional location information or process positional location information from external entities and may be configured for communicating with external entities (e.g. server) for receiving updates of new information or receiving updates for replacing obsolete information. Non-limiting examples of information which may be updated from external entities for processing of applied motions includes software, firmware, landmarks, places of business, highways, streets, roads, hazards, bodies of water and geographic terrain. Non-limiting examples of external entities which motion subsystem may receive positional location information includes GPS, Wi-Fi, cell-tower positioning systems, compasses, accelerometers, gyroscopes and magnetic sensors. Motion processing subsystem may operate to store a log of processing information. Non-limiting examples of uses for a log of processing information include viewing, analysis and diagnostics.

In other embodiments of the present invention, a method and means will be described which provides means and methods for modifying and interacting with a display of information as presented and viewed by a user on a GUI of a stand-alone suitable device. Non-limiting examples of suitable devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include GPS, Wi-Fi, cell-tower positioning systems, compasses, accelerometers, gyroscopes and magnetic sensors. Modification of and interaction with display of information as presented on a GUI may be initiated and controlled by user applying motions using one or more fingers to a touch-screen interface device. Non-limiting examples of touch-screen motions include slides, flicks, taps, points, pinches, swipes and alpha numeric characters. A touch-screen motion subsystem located within or attached to suitable device may process applied touch-screen motions to effect modifications of and interactions with information as displayed on GUI. Non-limiting examples of processing which may be used by touch-screen motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples for the types of graphical information which may be presented include road, satellite or terrain. Non-limiting examples of interactions performed with display of information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Touch-screen motion subsystem may receive positional location information or process positional location information from external entities and may be configured as stand-alone without requiring additional information from outside entities (e.g. networked servers) for processing and implementing applied motions. Non-limiting examples of external entities which touch-screen motion subsystem may receive positional location information includes GPS, Wi-Fi, cell-tower positioning systems, compasses, accelerometers, gyroscopes and magnetic sensors. Motion processing subsystem may operate to store a log of processing information. Non-limiting examples of uses for a log of processing information include viewing, analysis and diagnostics.

In other embodiments of the present invention, a method and means will be described which provides for modifying and interacting with a display of information as presented and viewed by a user on a GUI of a suitable device which may be networked with a server device for accessing additional information. Non-limiting examples of suitable devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include GPS, Wi-Fi, cell-tower positioning systems, compasses, accelerometers, gyroscopes and magnetic sensors. Modification of and interaction with display of information as presented on a GUI may be initiated and controlled by user applying motions using one or more fingers to a touch-screen interface device. Non-limiting examples of touch-screen motions include slides, flicks, taps, points, pinches, swipes and alpha numeric characters. A touch-screen motion subsystem located within or attached to suitable device may process applied motions to effect modifications of and interactions with information as displayed on GUI. Non-limiting examples of processing which may be used by touch-screen motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples for the types of graphical information which may be presented include road, satellite or terrain. Non-limiting examples of interactions performed with display of information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Touch-screen motion subsystem may receive positional location information or process positional location information from external entities and may be configured for communicating with external entities (e.g. server) for acquiring additional information for processing and implementing applied motions. Non-limiting examples of information which may be acquired from external entities for processing of applied motions includes landmarks, places of business, highways, streets, roads, hazards, bodies of water and geographic terrain. Non-limiting examples of external entities which touch-screen motion subsystem may receive positional location information includes GPS, Wi-Fi, cell-tower positioning systems, compasses, accelerometers, gyroscopes and magnetic sensors. Motion processing subsystem may operate to store a log of processing information. Non-limiting examples of uses for a log of processing information include viewing, analysis and diagnostics.

In other embodiments of the present invention, a method and means will be described which provides for modifying and interacting with a display of information as presented and viewed by a user on a GUI of a stand-alone device which may be networked with a server device for receiving updates of new information or receiving updates for replacing obsolete information. Non-limiting examples of suitable devices include mobile phones, smartphones, PDAs, tablets, wrist watches, mp3 audio players and portable laptop computers. Furthermore, suitable devices may incorporate location awareness capabilities for determining geographic location information. Non-limiting examples for which suitable devices may determine location information include GPS, Wi-Fi, cell-tower positioning systems, compasses, accelerometers, gyroscopes and magnetic sensors. Modification of and interaction with display of information as presented on a GUI may be initiated and controlled by user applying motions using one or more fingers to a touch-screen interface device. Non-limiting examples of touch-screen motions include slides, flicks, taps, points, pinches, swipes and alpha numeric characters. A touch-screen motion subsystem located within or attached to suitable device may process applied motions to effect modifications of and interactions with information as displayed on GUI. Non-limiting examples of processing which may be used by touch-screen motion subsystem to process applied motions includes naming, characterizing, detecting, measuring, quantifying, comparing, matching, application of thresholds, application of variances, mathematical processing, digital signal processing, information retrieving, information transmitting, information receiving and logging of process information. Variance parameter may operate to indicate an acceptable deviation from the initial motion for a subsequent motion to be considered valid (e.g. 20%). Non-limiting examples of phenomena for which variances may be supported include angle, direction, speed and motion length. Non-limiting examples for which variances may be applied include any x-, y-, z- axis or any combination thereof or for any length of movement. Non-limiting examples of modifications applied to display of information as presented on GUI may include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Non-limiting examples for the types of graphical information which may be presented include road, satellite or terrain. Non-limiting examples of interactions performed with display of information as presented on GUI may include changing radius, changing sector, changing style of information, changing center, changing orientation, clicking buttons, selecting off-on switch, selecting picker wheel and sliding slider. Motion processing subsystem may receive location information and motion information in real-time or delayed (e.g. buffering or caching). Motion processing subsystem may incorporate internal and/or external processors, storage and communications capabilities. Touch-screen motion subsystem may receive positional location information or process positional location information from external entities and may be configured for communicating with external entities (e.g. server) for receiving updates of new information or receiving updates for replacing obsolete information. Non-limiting examples of information which may be updated from external entities for processing of applied motions includes software, firmware, landmarks, places of business, highways, streets, roads, hazards, bodies of water and geographic terrain. Non-limiting examples of external entities which touch-screen motion subsystem may receive positional location information includes GPS, Wi-Fi, cell-tower positioning systems, compasses, accelerometers, gyroscopes and magnetic sensors. Motion processing subsystem may operate to store a log of processing information. Non-limiting examples of uses for a log of processing information include viewing, analysis and diagnostics.

In other embodiments of the present invention, a method and means will be described which provides for creating new command and touch-screen motion definitions and modifying existing command and touch screen motion definitions for interacting with a display of information as presented and viewed by a user on a GUI of a suitable device. Furthermore, these embodiments of the present invention may operate to enable user to create names and associate names with command and touch-screen motion definitions and store name associated command and touch-screen definitions. Non-limiting examples of applied motions which may be named and defined include upward, downward, left, right, circular and textually shaped. For example for textually shaped, a user may perform a motion representing the alpha character “A”. Furthermore, non-limiting examples of applied motions include motion for any x-, y-, z- axis or combination thereof, for a specific distance of travel, for a specific time period or for motion bounded by coordinate limits. Non-limiting examples of touch-screen motions which may be named and defined include slides, flicks, taps, points, pinches, swipes and alpha numeric characters. In a non-limiting example, an applied motion moving the device quickly to the left may be processed as a touch-screen flick motion to the left. Non-limiting examples of motion commands which may be named and associated with command and touch-screen motion definitions include increasing viewing scale, decreasing viewing scale, changing direction orientation, changing type of information displayed, increasing sector radius, decreasing sector radius, right rotation, left rotation, increasing sector depth, decreasing sector depth, selecting location, displaying location details and selecting a place-of-interest. Furthermore, these embodiments of the present invention may operate to enable user to associate sounds and vibrations with command and touch-screen motion definitions. Non-limiting examples of sounds which may be associated with command and touch-screen definitions include ringing, buzzing, beeping, squeaking and chirping. Non-limiting examples of vibrations which may be associated with command and touch-screen definitions include short vibration, long vibration, intermittent vibration and intermixed short and long vibrations. Furthermore, these embodiments of the present invention may operate to enable users to generate sounds and vibrations on remote devices via a communication network. Furthermore, these embodiments of the present invention may operate to enable user to associate programs and applications with command and touch-screen motion definitions. Non-limiting examples of programs and applications which may be associated with command and touch-screen motions definitions include word processing, spreadsheet, email, chat, text messaging, Internet browser, audio player and video player. Furthermore, these embodiments of the present invention may operate to enable applications to support differing sets of command and touch-screen motions. For example, one word-processing application may support saving a file with an upward motion and a spreadsheet application may support saving a file with a downward motion. Furthermore, these embodiments of the present invention may operate to support differing command and touch-screen motions based upon the context of the information presented on the GUI. For example, an upward motion may indicate an increase in the range for a presented geographical illustration and in a different context (e.g. selecting text) an upward motion may indicate moving a curser upward in a list of text. Furthermore, these embodiments of the present invention may operate to enable a user to associate a multiplicity of motion commands, sounds, vibrations and/or programs and applications with command and touch-screen motion definitions. For example, a user may operate to open a word-processing application, generate a sound and generate a vibration simultaneously with a single command and touch-screen motion. Furthermore, these embodiments of the present invention may operate to segregate motion and touch-screen commands between multiplicities of users. For example, one user may operate to open an application with a downward movement and another user may operate to open an application with an upward movement. Motion processing subsystem may operate to store a log of processing information. Non-limiting examples of uses for a log of processing information include viewing, analysis and diagnostics. Furthermore, motion processing subsystem may operate to support varying motion and touch-screen commands based on varying locations. For example, an upward motion in on location may represent increase scale, where in a different location an upward motion may represent decrease scale. Furthermore, motion processing subsystem may operate to support a specific set of motion and touch-screen commands based on a specific location. Furthermore, motion processing subsystem may operate to support motion and touch-screen commands for selecting POIs. Furthermore, motion processing subsystem may operate to support system-defined motion and touch-screen commands. Furthermore, motion processing system may operate to support a library of predefined motion and touch-screen definitions and commands. Furthermore, motion processing subsystem may operate to support motion and touch-screen commands for identifying a target or POI.

In other embodiments of the present invention, a method and means will be described which provides for using motions of a suitable device to indicate letters, symbols, drawings, or language sounds rather than using an actual keyboard, touch-screen keypad, or sounding device. Non-limiting examples of applied motions which may be named and defined are the alpha character “A”, alpha character “B”, through the alpha character “Z” as well as special characters such as “>”, “.”, “ ” (space) etc. Furthermore, non-limiting examples of applied motions include motion for any x-, y-, z- axis or combination thereof, for a specific distance of travel, for a specific time period or for motion bounded by coordinate limits. Furthermore, some embodiments of the present invention may operate to support differing command and touch-screen motions based upon the context of the information presented on the GUI. In a non-limiting example, a user may perform a motion representing the alpha character “A” to mean the alpha character “A” when in a keyboard text application and to mean “Arrival date, time, and location” when in a travel application. Furthermore, some embodiments of the present invention may operate to enable a user to associate a multiplicity of motion commands, sounds, vibrations and/or programs and applications with command and touch-screen motion definitions. Furthermore, some embodiments of the present invention may operate to segregate motion and touch-screen commands between multiplicities of users. In a non-limiting example, one user may use the alpha character “A” to mean “A” and another user may wish alpha character “A” to mean “Arthur”. While the US alphabet has been used as an example, non-limiting examples of applied motions include motions for the letters and/or symbols and/or sounds in alphabets and languages such Russian, Chinese, Japanese, Inca, or Peruvian. Furthermore, some embodiments of the present invention may operate to enable a user to associate a multiplicity of motion commands, sounds, vibrations and/or programs and applications with letters or language. In a non-limiting example, a user may, generate a sound that has one meaning in the Chinese language and another in Japanese. Furthermore, some embodiments of the present invention may operate to segregate motion and touch-screen commands between multiplicities of users. In a non-limiting example, one user may operate using the English alphabet whereas the symbol “A” means the letter “A” while another use operates in the Inca language where the symbol “A” may mean “East”, “East” being a symbol or hieroglyphic drawing in the Incan language. Motion processing subsystem may operate to store a log of processing information. Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for using motions of a suitable device to capture shapes. Non-limiting examples of applied motions which may be named and defined are circles, rectangles and free-form shapes. For example, a non-limiting example of a flowchart application could have applied motions defined for various symbols such as a start/end block (the motion being a rectangle with curved left and right sides, process block (rectangle), decision node (diamond), process flows (arrows), etc. The applied motions could (1) mimic the symbols being identified or (2) be completely different—the letter “A” meaning a start/end block, the letter “B” meaning a process block, the letter “C” meaning a decision node, etc. For another example, a non-limiting example of a free-form motion capture application to capture images that are stored WYSIWYG (“What You See is What You Get”) on the device could have the device store all motions that were performed by a user when in a specific application, for a specific time period, or between one defined motion for the start of the free-form motion capture and another defined motion for the end of the free-form motion capture. Furthermore, non-limiting examples of applied motions include motion for any x-, y-, z- axis or combination thereof, for a specific distance of travel, for a specific time period or for motion bounded by coordinate limits. Motion processing subsystem may operate to store a log of processing information. Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for using motions of a TV remote control device or general audio visual remote control device to send commands to equipment which can receive electronic, infrared, or other signals that can be created by the device. Non-limiting examples of applied motions which may be named and defined are on, off, increase volume, decrease volume, up and down, pause, start, stop, speed ahead fast, speed ahead slow, rewind fast, rewind slow, live, search, record, start recording, stop recording, view guide, scroll up, scroll down, scroll left, scroll right, last, show information, mute, show favorites, zoom, picture-in-picture on, picture-in-picture off, select a channel, select a number, help, TV, cable, aux, power, setup, etc. In one non-limiting example, the user would use applied motions processed by the TV or general audio visual remote control device. In a non-limiting example, one applied motion would be associated with the audio visual remote control device “on” command or “power on” command. When the user performed an applied motion associated with “on” command (perhaps the letter “O” or perhaps an upward swipe), the motion processing subsystem would convert the applied motion to one or more commands recognized by audio visual remote control device and send those commands to the TV, cable box, and/or other equipment controlled by the audio visual remote control device. Furthermore, non-limiting examples of applied motions include motion for any x-, y-, z- axis or combination thereof, for a specific distance of travel, for a specific time period or for motion bounded by coordinate limits. Motion processing subsystem may operate to store a log of processing information. Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for using motions of a suitable device to send commands to equipment which can receive electronic, infrared, or other signals that can be created by a GUI device. Non-limiting examples of applied motions which may be named and defined are on, off, increase volume, decrease volume, up and down, pause, start, stop, speed ahead fast, speed ahead slow, rewind fast, rewind slow, live, search, record, start recording, stop recording, view guide, scroll up, scroll down, scroll left, scroll right, last, show information, mute, show favorites, zoom, picture-in-picture on, picture-in-picture off, select a channel, select a number, help, TV, cable, aux, power, setup, etc. In one non-limiting example, the user would use applied motions on a GUI device to mimic a TV or general audio visual remote control device. For example, one applied motion on the GUI device would be associated with the audio visual remote control device “on” command or “power on” command. When the user performed an applied motion associated with “on” command (perhaps the letter “O” or perhaps an upward swipe) using the GUI device, the motion processing subsystem would convert the applied motion to one or more audio visual device commands and send those commands to the TV, cable box, and/or other equipment as if the GUI device was the audio visual remote control device. Furthermore, non-limiting examples of applied motions include motion for any x-, y-, z- axis or combination thereof, for a specific distance of travel, for a specific time period or for motion bounded by coordinate limits. Motion processing subsystem may operate to store a log of processing information. Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for using device motions to provide a security validation via a user's personal Security Motion. Rather than type a password a user will enter an applied motion to validate their interaction with a GUI device. The GUI device could be a suitable device, PC with a GUI device attached, etc. In one non-limiting example of the process of this embodiment, the user would perform an applied motion that would be stored by the motion processing subsystem either on the GUI device or on a server. The stored applied motion would be the user's Security Motion and be processed much like a typed password is processed. Applications which require security would then request the user to perform their Security Motion, similar to requesting a password, in order to continue processing. The application would compare the performed applied motion the stored Security Motion and would only continue processing if there was a match. Similar to passwords, a user would be able change or delete their stored Security Motion. Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for using device motions to provide a security validation via a challenge-response process in which a user will enter an applied motion to validate their interaction with a GUI device. Rather than type a captcha (Completely Automated Public Turing test to tell Computers and Humans Apart) a user will enter an applied motion to validate their interaction with a GUI device. The GUI device could be a mobile device, PC with a GUI device attached, etc. In one non-limiting example of the process of this embodiment, the user would be prompted to enter an applied motion by an application when security is of concern. The application would compare the user's applied motion with the requested motion and continue processing only if there was a match. In a non-limiting example, when completely checkout of an on-line purchase, the on-line purchase application would ask the user to create a circle using the GUI device. If the user did move the GUI device in a circular motion then the processing would continue. If no circular motion was detected, the processing would not continue. The application would use an algorithm to prompt users for varying motions (e.g. using the above example, a user may be prompted to draw a circle, rectangle, triangle, dot, etc.—not always a circle). Non-limiting examples of uses for a log of processing information include viewing, analysis and diagnostics. Furthermore, motion processing subsystem may operate to support varying motion and touch-screen commands based on varying locations. Furthermore, motion processing subsystem may operate to support a specific set of motion and touch-screen commands based on a specific location. Furthermore, motion processing subsystem may operate to support system-defined motion and touch-screen commands. Furthermore, motion processing system may operate to support a library of predefined motion and touch-screen definitions and commands.

In other embodiments of the present invention, a method and means will be described which provides for displaying geographical information. Non-limiting examples of geographical information which may be displayed include street map, satellite, terrain and/or earth views. Geographical information displays may be high level (e.g. the Earth) or detailed level (e.g. view of a house or partial house). Non-limiting examples of other information which may be displayed include roads, restaurants, POIs, and photographs.

In other embodiments of the present invention, a method and means will be described which provides for modifications for future displays of information. A performed command or touch-screen motion may operate to be anticipated and incorporated in future displays of information. For example, a user and an associated suitable device may be in motion and as a result of the motion the current graphical information presented to user may not accurately represent actual events. Embodiments of the present invention may operate to anticipate and process for future events and situations based on current and previous locations and motions. In a non-limiting example, a user may be driving a car and a passenger may use a suitable device that identifies points of interest (e.g. coffee shops) for the future five miles of travel on the road being driven (‘Road A’, continuously changing as the road is being driven. One non-limiting embodiment of the present invention would be for the passenger to make a motion such as an upward swipe that has been defined to increase the search distance. Using such a non-limiting embodiment of the present invention, the device would then identify identifies points of interest (e.g. coffee shops) for the next ten miles of future travel on the current Road A. If travel plans change and the driver takes an exit to a different road (‘Road B’), the invention would then identify points of interest (e.g. coffee shops) for the next ten miles of future travel on Road B, not Road A.

In other embodiments of the present invention, a method and means will be described which provides for modifications of a display of information via a location-aware computer peripheral.

In other embodiments of the present invention, exemplary features and functions may be performed in total within the device, partially within the device and partially on a server or other network-connected or Internet-connected computer processing system, or in total on a server or other network-connected or Internet-connected computer processing system. The various embodiments may be implemented in hardware, software/firmware or a combination of hardware and software/firmware. Data stores, such as motion and touch-screen command definitions, may be identified and the data stores may be one file, more than one file, one database, more than one database, a combination of files and databases, or other storage mechanisms. Other embodiments of the present invention may have less or more data stores than described in the figures. Data may be textual information, and/or structured or relational information, and/or binary large objects, and/or other data store formats and content.

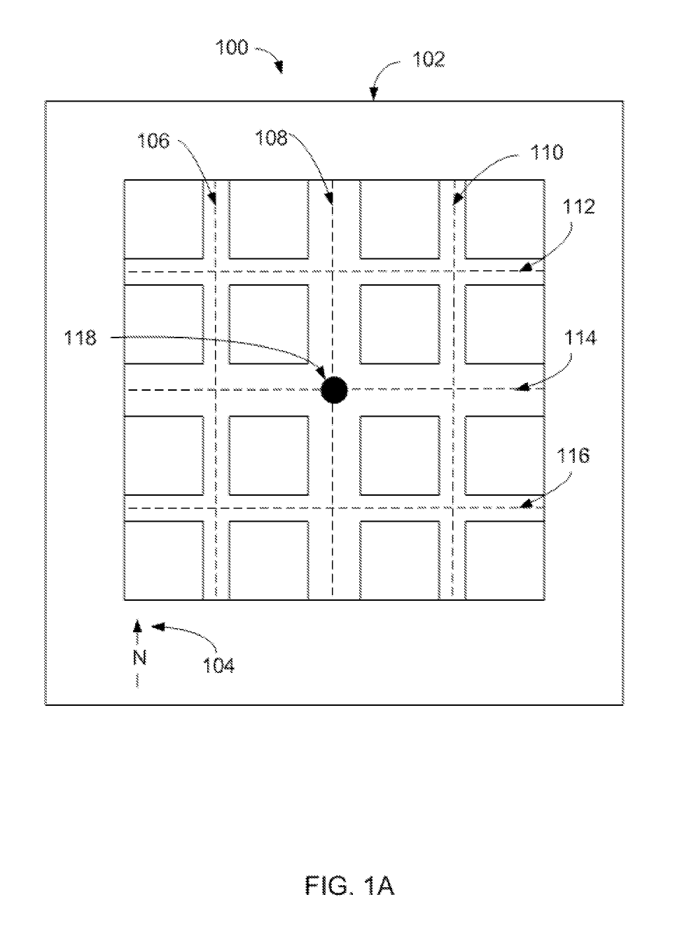

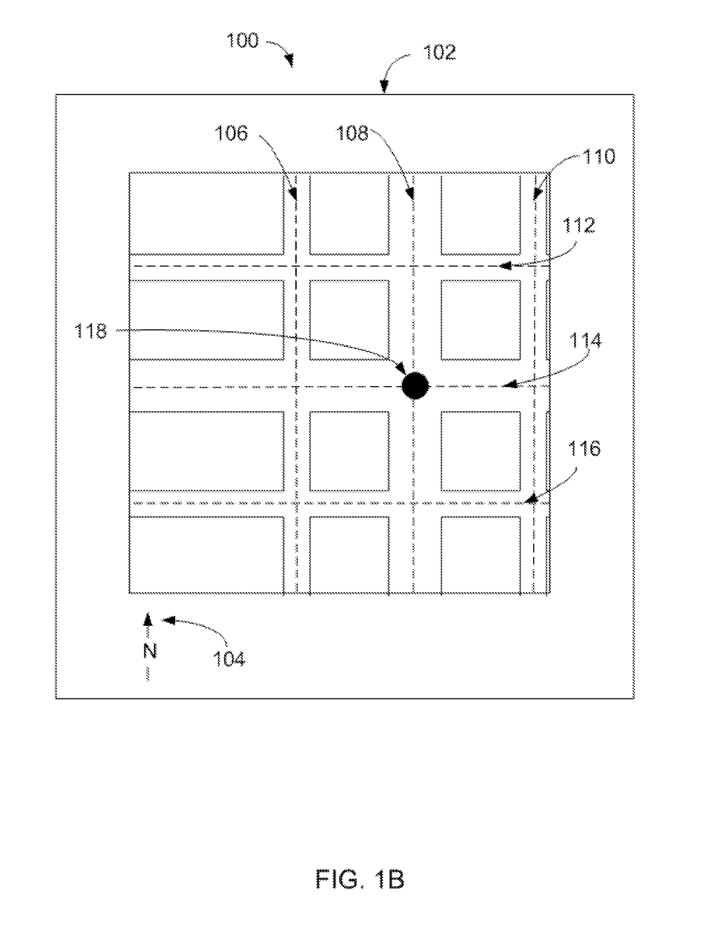

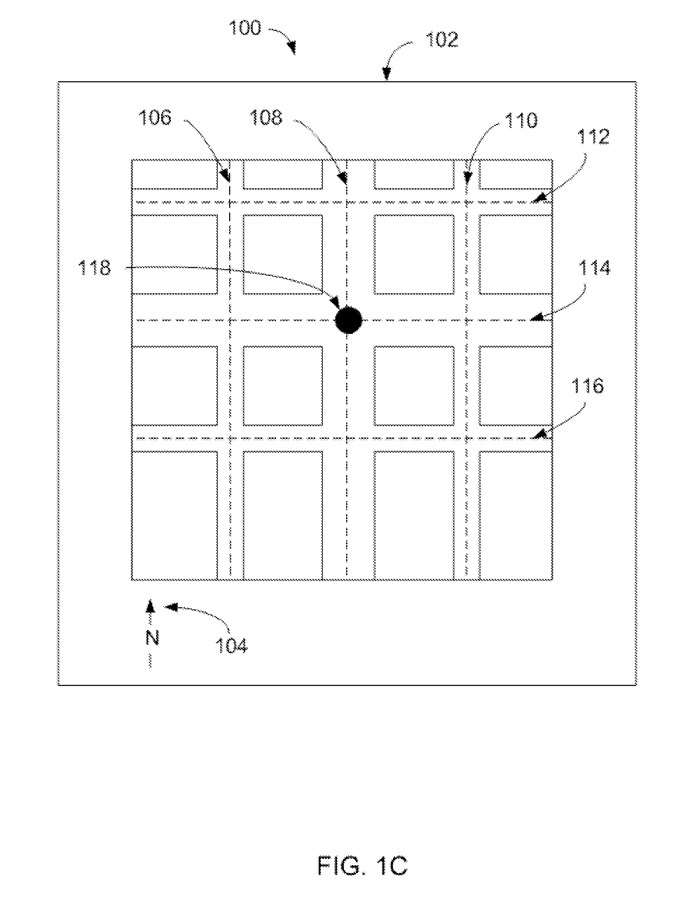

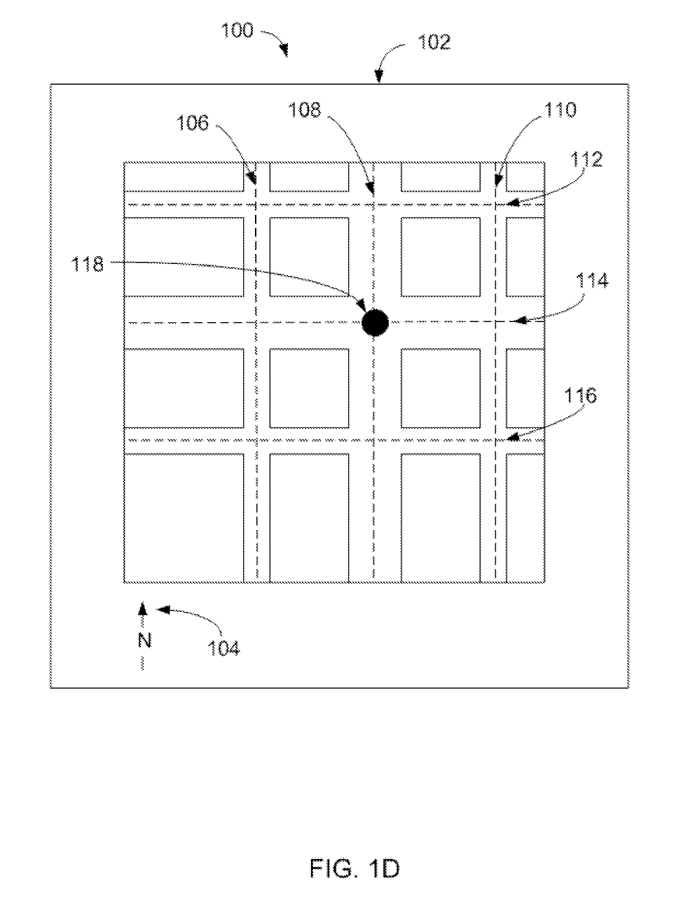

FIG. 1A illustrates a display of information as viewed by a user on a GUI for an exemplary embodiment of the present invention.

An information display 100 includes a display area 102, a geographic direction indicator 104, a vertical street 106, a vertical street 108, a vertical street 110, a horizontal street 112, a horizontal street 114, a horizontal street 116 and a location indicator 118.

Geographic direction indicator 104 may operate to inform user (not shown) of the magnetic poles of the Earth with respect to the other geographical information presented in display area 102. Vertical street 106, vertical street 108 and vertical street 110 may operate to represent vertical avenues of travel. Horizontal street 112, horizontal street 114 and horizontal street 116 may operate to represent horizontal avenues of travel. Location indicator 118 may operate to indicate the location of a device (not shown) containing or attached to information display 100 in order to illustrate the position of location indicator 118 with respect to other geographical information presented on display area 102.

FIG. 1B illustrates a modified version of FIG. 1A where the display of information as viewed by a user on a GUI has been modified such that additional information has been presented to the West of location indicator 118 and less information has been presented to the East of location indicator 118.

FIG. 1C illustrates a modified version of FIG. 1A where the display of information as viewed by a user on a GUI has been modified such that additional information has been presented to the South of location indicator 118 and less information has been presented to the North of location indicator 118.

FIG. 1D illustrates a modified version of FIG. 1A where the display of information as viewed by a user on a GUI has been modified such that additional information has been presented to the West and South of location indicator 118 and less information has been presented to the East and North of location indicator 118.

FIG. 1A-D illustrate how a display of information presented on a GUI may be modified. Other modifications for how information may be presented on a GUI may also be supported. Non-limiting examples of other modifications of information which may be presented on a GUI include rotate, zoom in, zoom out, text entry, check box selections and radio button selections.

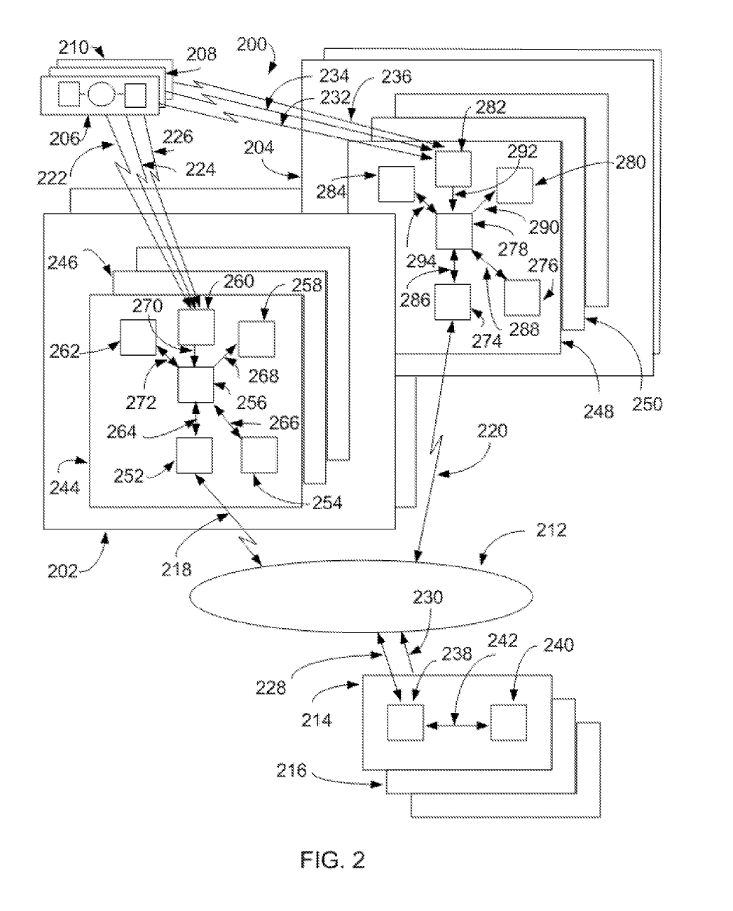

FIG. 2 illustrates a block diagram depicting an exemplary regionalized client/server communication system supporting location aware capabilities for providing motion and touch-screen motion commands, in accordance with an embodiment of the present invention.

A communication system 200 includes a multiplicity of networked regions with a sampling of regions denoted as a network region 202 and a network region 204, a multiplicity of positioning satellites with a sampling denoted as a positioning satellite 206, a positioning satellite 208 and a positioning satellite 210, a global network 212 and a multiplicity of servers with a sampling of servers denoted as a server device 214 and a server device 216.

Network region 202 and network region 204 may operate to represent a network contained within a geographical area or region. Elements within network region 202 and 204 may operate to communicate with external elements within other networked regions or within elements contained within the same network region.

Positioning satellite 206, positioning satellite 208 and positioning satellite 210 may operate to enable devices to determine their geographic position with respect to the Earth.

In some implementations, global network 212 may operate as the Internet. It will be understood by those skilled in the art that communication system 200 may take many different forms. Non-limiting examples of forms for communication system 200 include local area networks (LANs), wide area networks (WANs), wired telephone networks, cellular telephone networks or any other network supporting data communication between respective entities via hardwired or wireless communication networks. Global network 212 may operate to transfer information between the various networked elements.

Server device 214 and server device 216 may operate to execute software instructions, store information and communicate with other networked elements. Non-limiting examples of software and scripting languages which may be executed on server device 214 and server device 216 include C, C++, C# and Java.

Network region 202 may operate to communicate bi-directionally with global network 212 via a communication channel 218. Network region 204 may operate to communicate bi-directionally with global network 212 via a communication channel 220. Network region 204 may operate to receive positioning information from positioning satellite 206 via a wireless communication channel 222, from positioning satellite 208 via a wireless communication channel 224 and from positioning satellite 210 via a communication channel 226. Server device 214 may operate to communicate bi-directionally with global network 212 via a communication channel 228. Server device 216 may operate to communicate bi-directionally with global network 212 via a communication channel 230. Network region 204 may operate to receive positioning information from positioning satellite 206 via a wireless communication channel 232, from positioning satellite 208 via a wireless communication channel 234 and from positioning satellite 210 via a wireless communication channel 236. Network region 202 and 204, global network 212 and server devices 214 and 216 may operate to communicate with each other and with every other networked device located within communication system 200.

Server device 214 includes a networking device 238 and a server 240. Networking device 238 may operate to communicate bi-directionally with global network 212 via communication channel 228 and with server 240 via a communication channel 242. Server 240 may operate to execute software instructions and store information.

Network region 202 includes a multiplicity of clients with a sampling denoted as a device 244 and a device 246. Device 244 includes a wireless networking device 252, a motion subsystem 254, a processor 256, a GUI 258, a satellite receiver device 260 and an interface device 262. Non-limiting examples of devices for GUI 258 include monitors, televisions, cellular telephones, smartphones and PDAs (Personal Digital Assistants). Non-limiting examples of interface device 262 include touch-screen, pointing device, mouse, trackball, scanner and printer. Wireless networking device 252 may communicate bi-directionally with global network 212 via communication channel 218 and with processor 256 via a communication channel 264. Motion subsystem 254 may communicate bi-directionally with processor 256 via a communication channel 266. GUI 258 may receive information from processor 256 via a communication channel 268 for display to a user for viewing. Satellite receiver device 260 may receive position information from positioning satellite 206 via wireless communication channel 222, from positioning satellite 208 via wireless communication channel 224, from positioning satellite 210 via wireless communication channel 226 and communicate positioning information to processor 256 via a communication channel 270. Interface device 262 may operate to send control information to processor 256 and to receive information from processor 256 via a communication channel 272. Network region 204 includes a multiplicity of clients with a sampling denoted as a device 248 and a device 250. Device 248 includes a wireless networking device 274, a motion subsystem 276, a processor 278, a GUI 280, a satellite receiver device 282 and an interface device 284. Non-limiting examples of devices for GUI 258 include monitors, televisions, cellular telephones, smartphones and PDAs (Personal Digital Assistants). Non-limiting examples of interface device 262 include touch-screen devices, pointing devices, mouses, trackballs, scanners and printers. Wireless networking device 274 may communicate bi-directionally with global network 212 via communication channel 220 and with processor 278 via a communication channel 286. Motion subsystem 276 may operate to communicate bi-directionally with processor 278 via a communication channel 288. GUI 280 may receive information from processor 278 via a communication channel 290 for display to a user for viewing. Satellite receiver device 282 may operate to receive positioning information from positioning satellite 206 via wireless communication channel 232, from positioning satellite 208 via wireless communication channel 234 and from positioning satellite 210 via wireless communication channel 236 and communicate positioning information to processor 278 via a communication channel 292. Interface device 284 may operate to send control information to processor 278 and to receive information from processor 278 via a communication channel 294.

For example, consider the situation where a user interfacing with device 244 may seek to modify the information presented on information display 100 in FIG. 1A with the information presented in FIG. 1B. In some embodiments, device 244 may have sufficient information to generate the desired modification and present user with the desired modification as illustrated by FIG. 1B and perform the operation without interacting or communicating with outside server devices (e.g. server device 214). In other embodiments, device 244 may operate to present user with the desired modification, but may use communication and interaction with external servers (e.g. server device 214) to update or refresh the information stored in device 244 during off-peak hours, for example. However, in other implementations device 244 may generally not have sufficient information to generate the desired modification requested using currently available information. In this case, device 244 may request the additional information needed from server device 214. For example, a user may enter a motion command to modify information display 100 using motion subsystem 254. The motion command may be communicated to processor 256 via communication channel 272. Processor 256 may then communicate the motion command to wireless networking device 252 via communication channel 264. Wireless networking device 252 may then communicate the motion command to global network 212 via communication channel 218. Global network 212 may then communicate the motion command to networking device 238 of server device 214 via communication channel 228. Networking device 238 may then communicate the motion command to server 240 via communication channel 242. Server 240 may receive the motion command and after processing the motion command may communicate display information to networking device 238 via communication channel 242. Networking device 238 may communicate the display information to global network 212 via communication channel 228. Global network 212 may communicate the display information to wireless networking device 252 via communication channel 218. Wireless networking device 252 may communicate the display information to processor 256 via communication channel 264. Processor 256 may communicate the display information to GUI 258 via communication channel 268. User may then view the modified information display 100 as illustrated in FIG. 1B on GUI 258.

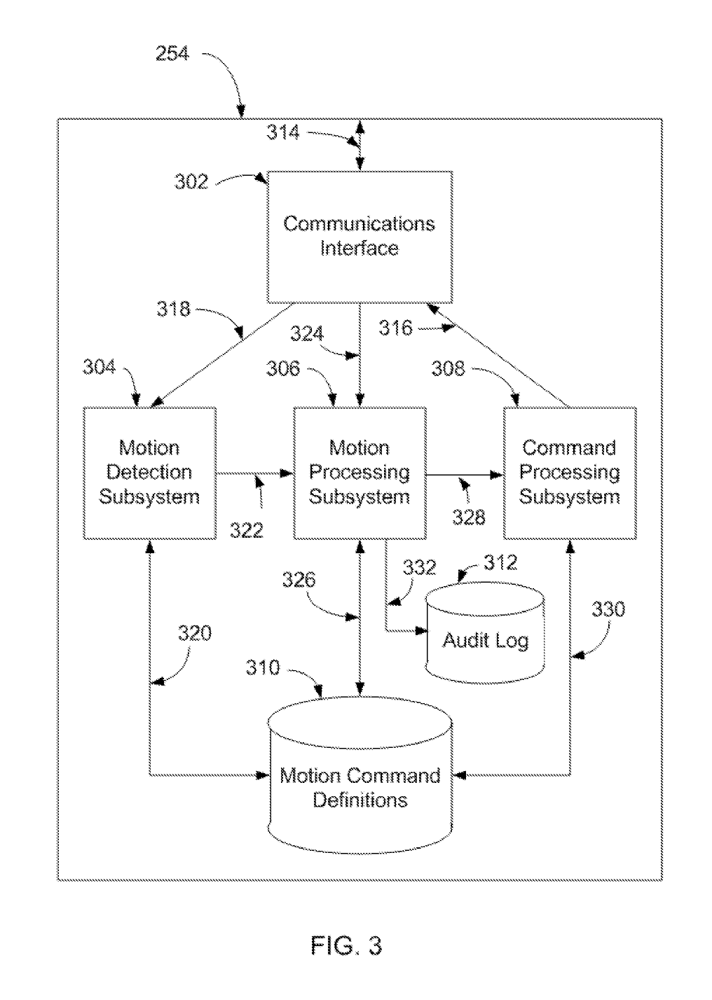

FIG. 3 illustrates a detailed version of motion subsystem 254 (FIG. 2), an exemplary embodiment of the present invention.

Motion subsystem 254 includes a communications interface 302, a motion detection subsystem 304, a motion processing subsystem 306, a command processing subsystem 308, a motion command definition storage 310 and an audit log storage 312.

Communications interface 302 may operate to communicate bi-directionally with entities located external to motion subsystem 254 (FIG. 2) via a communication channel 314 and receive information from command processing subsystem 308 via a communication channel 316. Motion detection subsystem 304 may operate to receive information from communications interface 302 via a communication channel 318 and communicate bi-directionally with motion command definition storage 310 via a communication channel 320. Motion processing subsystem 306 may operate to receive information from communications interface 302 via a communication channel 324 and from motion detection subsystem 304 via a communication channel 322, and communicate bi-directionally with motion command definition storage 310 via a communication channel 326. Command processing subsystem 308 may operate to receive information from motion processing subsystem 306 via a communication channel 328 and communicate bi-directionally with motion command definition storage 310 via a communication channel 330. Audit log storage 312 may operate to receive information from motion processing subsystem 306 via a communication channel 332.

Motion subsystem 254 may operate to process command and touch-screen motions, store and retrieve command and touch-screen motions, associate command and touch-screen motions with commands, perform and communicate commands and store processing information.

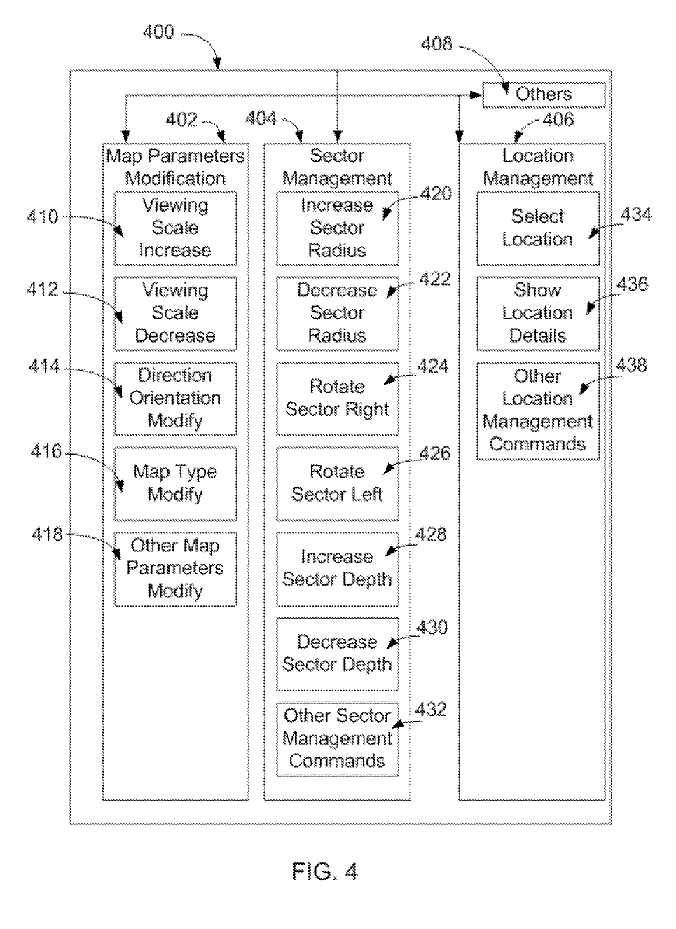

FIG. 4 illustrates a command hierarchy for an exemplary embodiment of the present invention.

A command hierarchy 400 includes a map parameters modify 402, a sector management 404, a location management 406 and an others 408.

Commands included in map parameters modify 402 may operate to modify the presentation of geographic map information as displayed to a user. Commands included in sector management 404 may operate to modify the presentation of a sector of geographical map information as displayed to a user. Commands included in location management 406 may operate to modify information presented with respect to a location of geographical map information as displayed to a user. Commands included in others 408 may operate to modify the display of information as presented to a user not otherwise modified by commands included in map parameters modify 402, sector management 404 and location management 406.

Map parameters modify 402 includes a viewing scale increase 410, a viewing scale decrease 412, a direction orientation modify 414, a map type modify 416 and an other map parameters modify 418.

Viewing scale increase 410 may operate to increase the scale of the presentation of geographical map information as displayed to a user. Viewing scale decrease 412 may operate to decrease the scale of geographical map information as displayed to a user. Direction orientation modify 414 may operate to modify the direction orientation of the presentation of geographical map information as displayed to a user. Map type modify 416 may operate to modify the type for the presentation of geographical map information as displayed to a user. Commands included in other map parameters modify 418 may operate to modify the display of information as presented to a user not otherwise modified by commands included in viewing scale increase 410, viewing scale decrease 412, direction orientation modify 414 and map type modify 416.

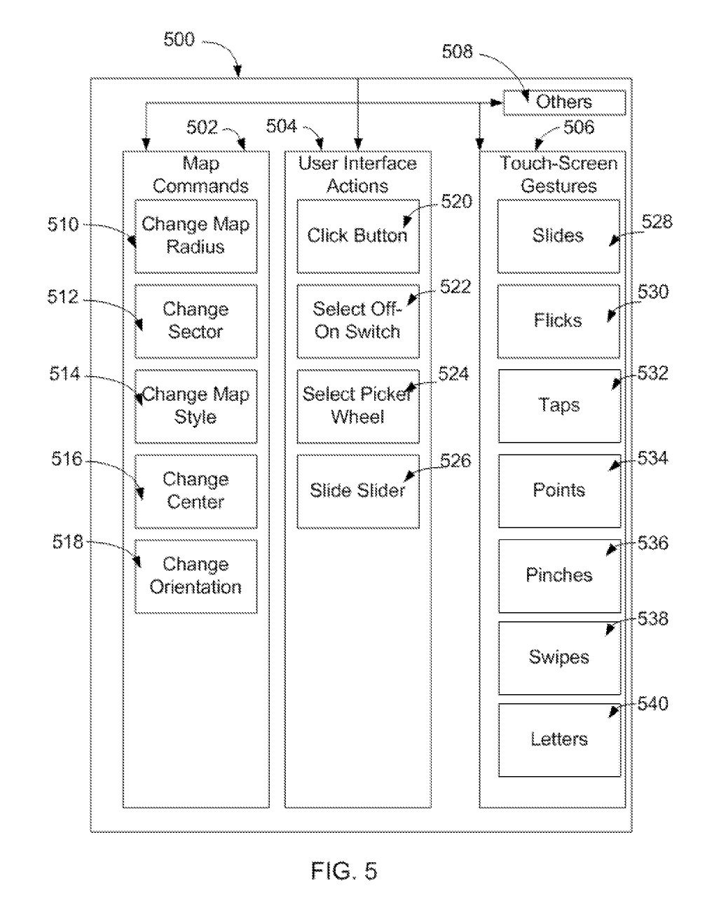

FIG. 5 illustrates a motion command hierarchy for an exemplary embodiment of the present invention.

A command hierarchy 500 includes a map commands 502, an user interface actions 504, a touch-screen gestures 506 and an others 508.

Commands included in map commands 502 may operate to modify the presentation of geographic map information as displayed to a user using motion commands. Commands included in user interface actions 504 may operate to enable a user to perform functions related to interfacing with a GUI using motion commands. Commands included in touch-screen gestures 506 may operate to enable a user to perform GUI interfacing functions using touch-screen gestures. Commands included in others 508 may operate to enable a user to execute commands not otherwise included in map commands 502, user interface actions 504 and touch-screen gestures 506.

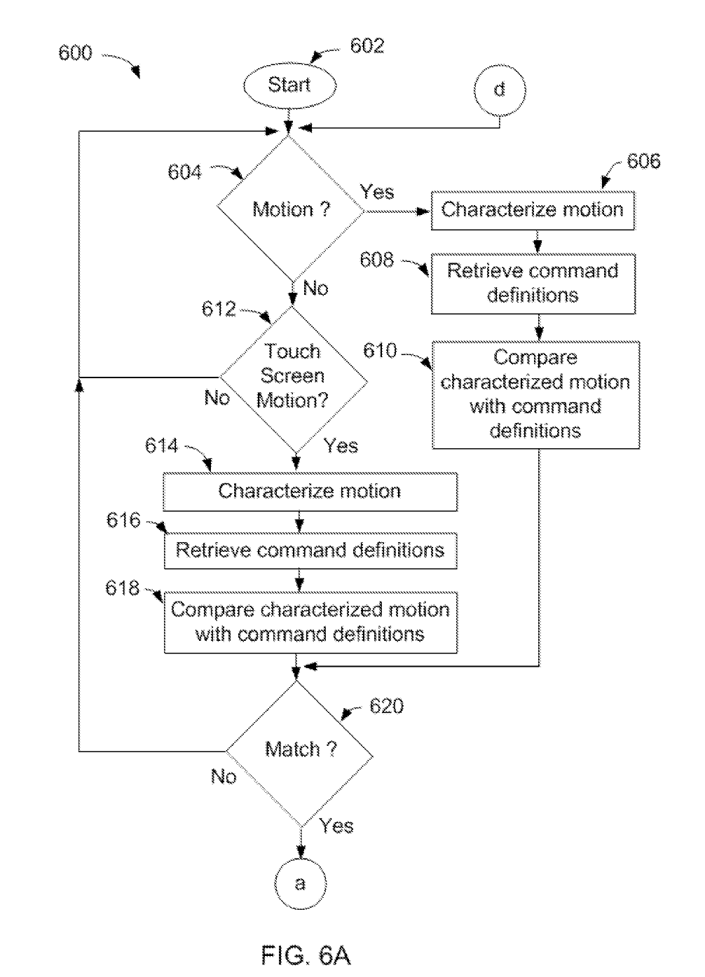

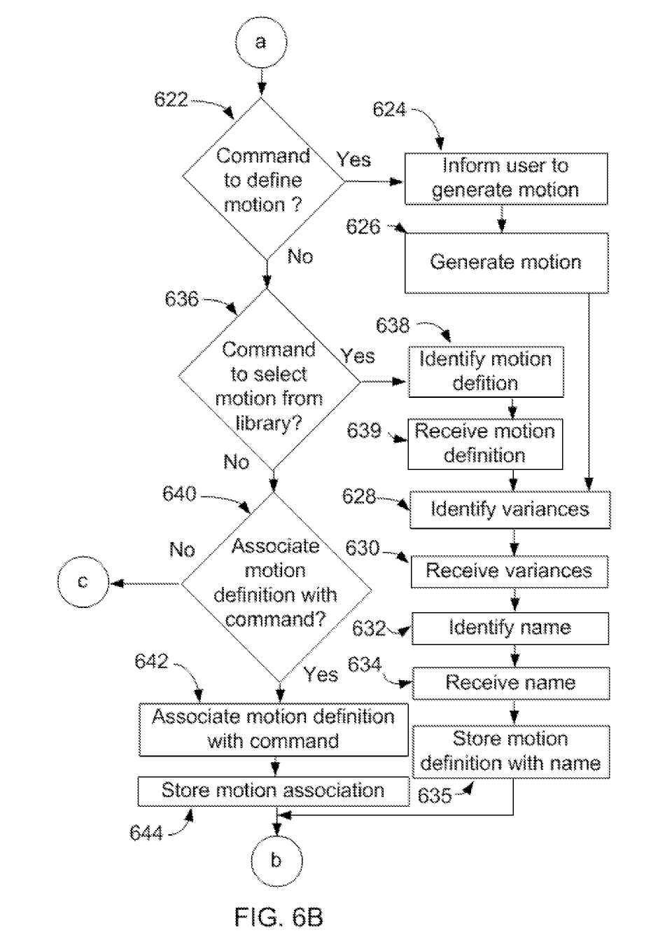

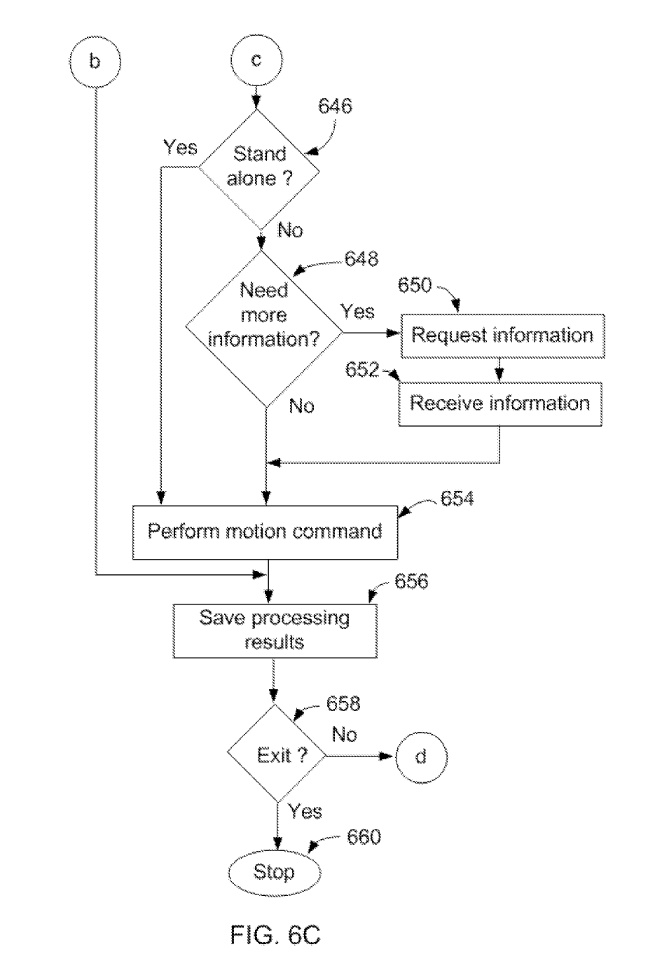

FIG. 6A-C illustrates operation of software/firmware for an exemplary embodiment of the present invention.

FIG. 6A-C illustrates a flow chart 600 illustrating an exemplary process for the execution of software or firmware in accordance with an embodiment of the present invention. In the present exemplary embodiment, the process initiates in a step 602 (FIG. 6A). The software/firmware may be operable for instruction execution and storage of information on device 244 (FIG. 2). In a step 604, it may be determined using motion detection subsystem 304 (FIG. 3) if a motion has occurred with respect to device 244 (FIG. 2). For a determination of motion occurring in step 604, motion processing subsystem 306 (FIG. 3) may in a step 606 receive motion information from motion detection subsystem 304 (FIG. 3) via communication channel 322 (FIG. 3) and may also operate to characterize the motion in step 606. In a step 608, motion processing subsystem 306 (FIG. 3) may operate to retrieve command definitions from motion command definition storage 310 (FIG. 3) via communication channel 326 (FIG. 3). In a step 610, motion processing subsystem 306 (FIG. 3) may operate to compare the characterized motion with retrieved motion command definitions. For a determination of no motion occurring in step 604, it may be determined in a step 612 if a touch-screen motion has occurred with respect to device 244 (FIG. 2) via interface device 262 (FIG. 2). For a determination of no touch-screen motion in step 612, execution of software/firmware may continue execution at step 604. For a determination of touch-screen motion in step 612, the touch-screen motion information may be communicated from interface device 262 (FIG. 2) to processor 256 (FIG. 2) via communication channel 272 (FIG. 2). Processor 256 (FIG. 2) may communicate touch-screen motion information to motion subsystem 254 (FIG. 2) via communication channel 266 (FIG. 2). Communications interface 302 (FIG. 3) may operate to receive touch-screen motion information via communication channel 314 (FIG. 3). Communications interface 302 may operate to communicate touch-screen motion information to motion processing subsystem 306 (FIG. 3) via communication channel 324 (FIG. 3). Motion processing subsystem 306 (FIG. 3) may operate to characterize the touch-screen motion information in a step 614. In a step 616, motion processing subsystem 306 (FIG. 3) may operate to retrieve touch-screen command definitions from motion command definition storage 310 (FIG. 3) via communication channel 326 (FIG. 3). In a step 618, motion processing subsystem 306 (FIG. 3) may operate to compare the characterized touch-screen motion information with retrieved touch-screen motion command definitions and communicate the results of the compare to command processing subsystem 308 (FIG. 3) via communication channel 328 (FIG. 3). In a step 620, it may be determined using command processing subsystem 308 (FIG. 3) if a match may have been found for a motion command following step 610 or for a touch-screen motion command following step 618. For a determination of no match in step 620, execution of software/firmware may continue execution at step 604. For a determination of a match in step 620, it may be determined in a step 622 (FIG. 6B) using command processing subsystem 308 (FIG. 3) if the motion or touch-screen motion command may be a command to define a motion. For a determination of a command to define a motion or a touch-screen motion in step 622, command processing subsystem 308 (FIG. 3) in a step 624 may communicate information for user to perform a motion or touch-screen motion command via communication channel 316 (FIG. 3), communications interface 302 (FIG. 3), communication channel 314 (FIG. 3), communication channel 266 (FIG. 2), processor 256 (FIG. 2), communication channel 268 (FIG. 2) and GUI 258 (FIG. 2). Following user observing information presented to perform motion or touch-screen motion command in step 624, user may in a step 626 perform movement of device 244 (FIG. 2) for a motion command or perform a touch-screen motion on interface device 262 (FIG. 2) for a touch-screen motion command.

For a motion command entered in step 626, motion detection subsystem 304 (FIG. 3) detects motion command, motion processing subsystem 306 (FIG. 3) characterizes and compares motion command with motion command definitions as previously discussed and communicates information to command processing subsystem 308 (FIG. 3). Command processing subsystem 308 (FIG. 3) may then communicate to user via GUI 258 (FIG. 2), in a similar manner as previously discussed, to enter variances for motion command in a step 628. Command processing subsystem 308 (FIG. 3) may then in a step 630 receive the variance information entered by user. Command processing subsystem 308 (FIG. 3) may then in a step 632 communicate to user via GUI 258 (FIG. 2), in a similar manner as previously discussed, to enter a name for the command motion. Command processing subsystem 308 (FIG. 3) may then in a step 634 receive the name information entered by user. Command processing subsystem 308 (FIG. 3) may then in a step 635 store the motion definition information for the related motion command in motion command definition storage 310 (FIG. 3) via communication channel 330 (FIG. 3).

For a touch-screen motion command entered in step 626, motion subsystem 254 (FIG. 2) receives touch-screen motion information from interface device 262 (FIG. 2) performed by user as previously discussed. Motion processing subsystem 306 (FIG. 3) characterizes and compares touch-screen motion command with touch-screen motion command definitions and communicates information to command processing subsystem 308 (FIG. 3). Command processing subsystem 308 (FIG. 3) may then communicate to user via GUI 258 (FIG. 2), in a similar manner as previously discussed, to enter variances for motion command in step 628. Command processing subsystem 308 (FIG. 3) may then in step 630 receive the variance information entered by user. Command processing subsystem 308 (FIG. 3) may then in step 632 communicate to user via GUI 258 (FIG. 2), in a similar manner as previously discussed, to enter a name for the touch-screen command motion. Command processing subsystem 308 (FIG. 3) may then in step 634 receive the name information entered by user. Command processing subsystem 308 (FIG. 3) may then in step 635 store the touch-screen motion definition information for the related touch-screen motion command in motion command definition storage 310 (FIG. 3) via communication channel 330 (FIG. 3).

For a determination of not a command to define a motion in step 622, it may be determined in a step 636 whether a command request to chose a command or touch-screen motion command from a library of command or touch-screen motions may have been selected. For a determination of choosing a command from a motion library in step 636, command processing subsystem 308 (FIG. 3) may in a step 638 present user, in a manner as previously discussed, with a request to identify a motion definition from a library of motion definitions via GUI 258 (FIG. 2). User may then in a step 639 communicate a selected command or touch-screen command motion definition to command processing subsystem 308 (FIG. 3), in a manner as previously discussed. Following step 639, the selected command or touch-screen command motion definition may be processed as previously discussed for steps 628, 630, 632, 634 and 635. For a determination of not choosing a command from a motion library in step 636, it may be determined in a step 640 whether a command to associate a command or touch-screen command motion with a command or touch-screen motion definition may have been communicated by user. For a communication from user for choosing to associate a motion command with a command or touch-screen command motion definition in step 640, command or touch-screen command motion may be associated with command in a step 642. In a step 644, the command or touch-screen command motion association generated in step 642 may be stored by command processing subsystem 308 in motion command definition storage 310 (FIG. 3). For a determination of not associating a command motion with a command motion definition in step 640, it may be determined in a step 646 (FIG. 6C) whether device 244 (FIG. 2) may be configured for stand-alone operation. For a determination of not being configured for stand alone in step 646, if may be determined in a step 648 whether command processing subsystem 308 (FIG. 3) may require additional information from server device 214 (FIG. 2) to complete execution of motion or touch-screen command. For a determination of needing more information in step 648, command processing subsystem 308 (FIG. 3) may in a step 650 communicate a request for additional information to communications interface 302 (FIG. 3) via communication channel 316. Communications interface 302 (FIG. 3) may communicate request for additional information to processor 256 (FIG. 2) via communication channel 314 (FIG. 3) and communication channel 266 (FIG. 2). Processor 256 (FIG. 2) may communicate request for additional information to wireless networking device 252 (FIG. 2) via communication channel 264 (FIG. 2). Wireless networking device 252 (FIG. 2) may communicate request for additional information to global network 212 (FIG. 2) via wireless communication channel 218 (FIG. 2). Global network 212 (FIG. 2) may communicate request for additional information to networking device 238 (FIG. 2) via communication channel 228 (FIG. 2). Networking device 238 (FIG. 2) may communicate request for additional information to server 240 (FIG. 2) via communication channel 242 (FIG. 2). Server 240 (FIG. 2) may receive and process request for additional information and communicate the additional information to command processing subsystem 308 (FIG. 3) in the reverse order as previously illustrated. In a step 652, command processing subsystem 308 (FIG. 3) may receive additional information transmitted by server device 214 (FIG. 2). For a determination of stand alone in step 646 or following step 652, the motion or touch-screen motion command may be performed in a step 654. For example, display area 102 (FIG. 1A) may have initially been presented to user via GUI 258. User may desire to view a different presentation of information, for example FIG. 1B, FIG. 1C or FIG. 1D. User may perform motion or touch-screen motion command to change presentation of information with the resulting new display of information presented to user (e.g. FIG. 1B, FIG. 1C or FIG. 1D). Furthermore, user may operate to perform other commands, for example the motion and touch-screen motion commands as illustrated in FIG. 4 and FIG. 5. Following the performance of motion or touch-screen command in step 654, or storing motion association information in step 644 (FIG. 6B) or storing named motion definition information in step 635 (FIG. 6B), processing results may be stored in a step 656. In a step 658 it may be determined if user seeks to exit execution of the software or firmware. For a determination of not exiting, execution of software/firmware continues execution at step 604 (FIG. 6A). For a determination of exit, execution of software/firm ceases to execute in a step 660.

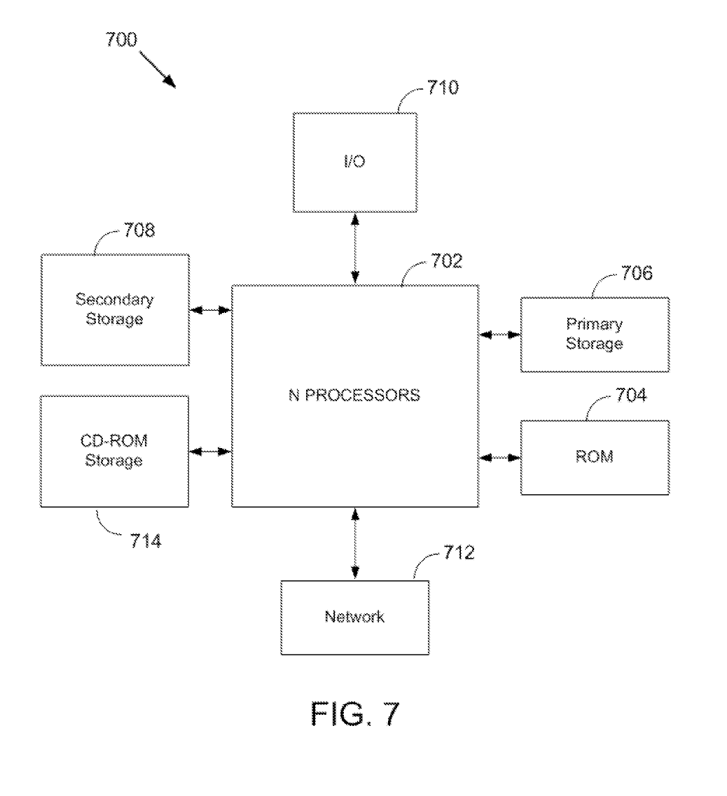

FIG. 7 illustrates a typical computer system that, when appropriately configured or designed, may serve as a computer system 700 for which the present invention may be embodied.

Computer system 700 includes a quantity of processors 702 (also referred to as central processing units, or CPUs) that may be coupled to storage devices including a primary storage 706 (typically a random access memory, or RAM), a primary storage 704 (typically a read only memory, or ROM). CPU 702 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 704 acts to transfer data and instructions uni-directionally to the CPU and primary storage 706 typically may be used to transfer data and instructions in a bi-directional manner. The primary storage devices discussed previously may include any suitable computer-readable media such as those described above. A mass storage device 708 may also be coupled bi-directionally to CPU 702 and provides additional data storage capacity and may include any of the computer-readable media described above. Mass storage device 708 may be used to store programs, data and the like and typically may be used as a secondary storage medium such as a hard disk. It will be appreciated that the information retained within mass storage device 708, may, in appropriate cases, be incorporated in standard fashion as part of primary storage 706 as virtual memory. A specific mass storage device such as a CD-ROM 714 may also pass data uni-directionally to the CPU.

CPU 702 may also be coupled to an interface 710 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 702 optionally may be coupled to an external device such as a database or a computer or telecommunications or internet network using an external connection shown generally as a network 712, which may be implemented as a hardwired or wireless communications link using suitable conventional technologies. With such a connection, the CPU might receive information from the network, or might output information to the network in the course of performing the method steps described in the teachings of the present invention.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, the functions provided by server devices 214 and 216 and global network 212 as illustrated in FIG. 2 and the operation of the example software/firmware embodiment as illustrated in FIG. 6A-C may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods for providing modification of a display of information as presented on a location-aware device according to the present invention will be apparent to those skilled in the art. The invention has been described above by way of illustration, and the specific embodiments disclosed are not intended to limit the invention to the particular forms disclosed. For example, the particular implementation of the GUI may vary depending upon the particular type of location-aware device used. The embodiments described in the foregoing were often directed to mobile implementations; however, it will be readily apparent to those skilled in the art, in light of the foregoing teachings, that similar techniques may be applied to non-mobile application. By way of example, without limitation, a suitable non-mobile device could be something like a 3-D mouse attached to a desktop system that could be adapted according to the teachings of the present invention; which especially is applicable to embodiment that include the capability to enter command not based on the current position of the device but upon a user specified location position; e.g., without limitation, one user is in San Francisco but command the device to show Boston geography on the display and therefore the 3D mouse motions act upon the display of Boston not current location of San Francisco. Such non-mobile implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising:
steps for detecting a motion applied to a computing device;
steps for characterizing said motion;
steps for retrieving command definitions;
steps for comparing said characterized motion with said retrieved command definitions;
steps for retrieving a command associated with a matched command definition; and
step for processing said retrieved command.

2. The method as recited in claim 1, further comprising steps for applying variance parameters to said characterized motion.

3. The method as recited in claim 1, further comprising steps for obtaining a positional location of said computing device for displaying map information.

4. A method comprising the steps of:
(a) detecting a motion applied to a computing device, wherein said motion comprises movement of said computing device about one or more axes;
(b) characterizing said motion;
(c) retrieving command definitions;
(d) comparing said characterized motion with said retrieved command definitions;
(e) retrieving a command associated with a matched command definition;
(f) processing a retrieved command to define a new motion by capturing said new motion from movement of said computing device about one or more axes, receiving a name for said new motion, characterizing said new motion, and storing said name and said characterized new motion as an entry in said command definitions;
(g) processing a retrieved command to select a stored characterized motion by retrieving a selected characterized motion from said stored command definitions, receiving a name for said selected characterized motion, and storing said name and said selected characterized motion as an entry in said command definitions;
(h) processing a retrieved command to associate a command with a stored characterized motion by receiving a command for said stored characterized motion, associating said received command with said stored characterized motion, and storing said associated command as an entry in said command definitions; and
(i) processing a retrieved command for modification of and interaction with displayed information of said computing device and saving processing results.

5. The method as recited in claim 4, further comprising the step of:
(j) applying variance parameters to said characterized motion.

6. The method as recited in claim 4, wherein step (f) further comprises obtaining variance parameters for said characterized new motion.

7. The method as recited in claim 4, wherein step (g) further comprises obtaining variance parameters for said selected characterized motion.

8. The method as recited in claim 4, wherein step (i) further comprises, requesting and receiving additional information from a server to process said retrieved command.

9. The method as recited in claim 4, further comprising the step of:
(k) obtaining a positional location of said computing device for displaying map information.

10. The method as recited in claim 9, wherein said positional location is obtained from a GPS.

11. The method as recited in claim 10, wherein processing of said retrieved command modifies parameters of said displayed map information.

12. The method as recited in claim 10, wherein processing said retrieved command modifies sector management of said displayed map information.

13. The method as recited in claim 10, wherein processing said retrieved command modifies location management of said displayed map information.

14. The method as recited in claim 4, wherein said interaction comprises selecting from a list.

15. The method as recited in claim 4, wherein said interaction comprises a challenge-response process.

16. A system comprising:
a motion detection subsystem for detecting a motions applied to a computing device about one or more axes;
a storage subsystem for storing motion command definitions;
a motion processing subsystem for characterizing said motions, retrieving command definitions, comparing said characterized motions with said retrieved command definitions, and retrieving commands associated with matched command definitions; and
a command processing subsystem for defining new motions and storing new characterized motions as entries in said command definition, retrieving stored characterized motions and storing named characterized motions as entries in said command definitions, associating commands with stored characterized motions and storing said associated commands as entries in said command definitions, and processing retrieved commands for modification of and interaction with displayed information of said computing device and saving processing results.

17. The system as recited in claim 16, further comprising a communication interface for requesting and receiving additional information from a server to process retrieved commands.

18. The system as recited in claim 16, wherein said motion processing subsystem further applies variance parameters to characterized motions.

19. The system as recited in claim 17, wherein said communication interface further receives a positional location of said computing device for displaying map information.

20. The system as recited in claim 19, wherein processing of said retrieved command modifies parameters of said displayed map information.
